(19) United States
(12) Patent Application Publication
(10) Pub. No.: US 2011/0009532 A1
(43) Pub. Date: Jan. 13, 2011

(54) BINDER ADDITIVES FOR COMPOSITE MATERIALS

(75) Inventors: Thomas LUETHGE, Consrade (DE); Maike Vivian Balbo Block, Hamburg (DE); Michael Magee, Midlothian, VA (US); Georg Burkhart, Essen (DE)

Correspondence Address: FROMMER LAWRENCE & HAUG, 745 FIFTH AVENUE- 10TH FL., NEW YORK, NY, 10151, US

(73) Assignee: Evonik Glodschmidt GmbH, Essen (DE)

(21) Appl. No.: 12/832,569

(22) Filed: Jul. 8, 2010

Related U.S. Application Data
(60) Provisional application No. 61/224,544, filed on Jul. 10, 2009.

(51) Int. Cl. C08L 1/00; C08K 5/5419; C08K 5/56; C08L 75/00; C08L 61/10; C08L 61/28; C08L 61/24

(52) U.S. Cl. 524/35; 524/267; 524/174; 524/589; 524/594; 524/597

(57) ABSTRACT

Compositions containing at least one binder and at least one surface-active additive in processes for the production of composite mouldings, and the use thereof.

Any foregoing applications and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to composite mouldings containing cellulose-containing, glass-, mineral-, polymer- and/or metal-containing materials, binder and at least one additive of the stated structure I and to the process for the production of these.

The production of these mouldings is preferably effected by hot pressing of materials coated with binders, the wetting of the materials by the binder having been improved by additives.

The production of generally compressed, shaped mouldings designated as composites, such as, for example, OSB (oriented strand boards), chip boards, fibre boards, plywood boards or cork boards and composite flake foams, with binders in an open or closed mould is known from numerous literature and patent publications WO 98/00464 (U.S. Pat. No. 5,908,496), U.S. Pat. No. 5,008,359, U.S. Pat. No. 5,140,086, U.S. Pat. No. 5,204,176, U.S. Pat. No. 3,440,189. The mouldings may consist of various types of cellulose-containing materials, for example chips, fibres or granules, but also straw or flax. In the production, catalysts, auxiliaries and/or further additives can optionally be concomitantly used.

In the production processes, temperatures of 0 to 400° C. are necessary in order to ensure the reaction of the binders with the cellulose-containing material and to permit the forming of the materials to give the desired final shape, such as, for example, boards. Pressures of 0-100 bar are reached or applied.

The proportion by mass of the binders, based on the total weight of the mouldings, is between 1 and 50% by weight, preferably 5 to 35% by weight and in particular less than 20% by weight, depending on the type of binder used and the type of composite.

Binders used are all types of polyfunctionalized isocyanates, typically aromatic polyisocyanates. The most widely used aromatic polyisocyanate is polymeric diphenylmethane diisocyanate (PMDI). In addition to the isocyanates, various formaldehyde resins are used as binders for composite mouldings. The most common ones include urea/formaldehyde, phenol/formaldehyde or melamine/formaldehyde resins and mixtures of these. Binders from renewable raw materials, such as tannins, lignins or proteins, are also used in small amounts.

An important factor in the production of composite mouldings, such as, for example, boards comprising cellulose-containing materials and binder, are the interfacial aspects between the individual particles or fibres and the binder. Two properties of the binder play an important role here: firstly, the depth of penetration of the binder into the material, but the wetting of the material surface, for example of the wood surface, with the binder is more important. By adding small amounts of additives in the form of surface-active substances, the surface tension of the binder is reduced, which leads to better spreading of the binder on the surface of the material. At the same time, the swelling behaviour of the pressed mouldings is positively influenced (less pronounced swelling).

It is therefore an object of the invention to provide novel composite mouldings with the use of compositions which modify the required binders so that better distribution of the binder on the surface occurs, which leads to improved adhesion and minimized swelling behaviour of the composite moulding.

The invention therefore relates to composite mouldings which were produced using compositions which contain at least one binder and at least one surface-active additive.

The surface-active additive may be an organic, preferably an organometallic and/or an organosilicon compound and in particular a siloxane of the formula (I).

The composite moulding comprises or consists of cellulose-, glass-, mineral-, polymer-, and/or metal-containing materials. The composite moulding preferably comprises cellulose, glass, mineral, polymer, and/or metal.

The invention furthermore relates to the composition itself, containing an organic binder and at least one surface-active substance. The surface-active substance in the compositions is preferably a siloxane of the formula (I).

The invention therefore furthermore relates to compositions which are distinguished in that they contain surface-active compounds of the formula (I)

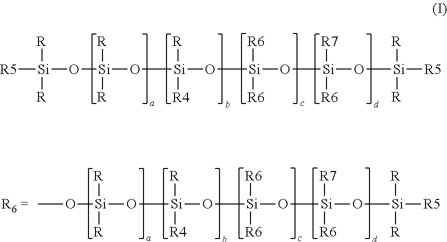

in which
a, independently of one another, is 0 to 500,
b, independently of one another, is 0 to 60,
c, independently of one another, is 0 to 10, preferably 0 or >0 to 5 and in particular 1, 2 or 3,
d, independently of one another, is 0 to 10, preferably 0 or >0 to 5 and in particular 1, 2 or 3,
   (for the terminal R⁶, c and d=0)
   with the proviso that, per molecule of the formula (I), the average number Σd of the T units and the average number Σc of the Q units per molecule are in each case not greater than 50, the average number Σa of the D units per molecule is not more than 2000 and the average number Σb of the silyloxy units carrying R4 per molecule is not more than 100,
R, independently of one another, is at least one radical from the group consisting of linear, cyclic or branched, aliphatic or aromatic, saturated or unsaturated hydrocarbon radicals having 1 to 20 C atoms, but preferably a methyl radical,
R5, independently of one another, is R4 or R,
R4, independently of one another, is an organic radical which is not R, or a fragment selected from the group consisting of

—CH₂—CH₂—CH₂—O—(CH₂—CH₂O—)ₓ—(CH₂—CH(R¹)O—)_{y}—R²

—CH₂—CH₂—O—(CH₂—CH₂O—)ₓ—(CH₂—CH(R¹)O—)_{y}—R²

—CH₂—R³

—CH₂—CH₂—(O)_{x′}—R³

—CH₂—CH₂—CH₂—O—CH₂—CH(OH)—CH₂OH

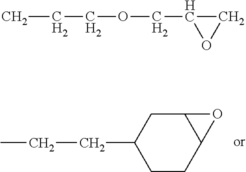

—CH₂—CH₂—CH₂—O—CH₂—C(CH₂OH)₂—CH₂—CH₃, in which
x is 0 to 100, preferably >0, in particular 1 to 50,
x′ is 0 or 1,
y is 0 to 100, preferably >0, in particular 1 to 50,
   R¹, independently of one another, is a substituted or unsubstituted alkyl or aryl group having 1 to 12 C atoms, for example a substituted alkyl radical, aryl radical or haloalkyl or haloaryl radical, it being possible for substituents R¹ differing from one another to be present within a radical R4 and/or a molecule of the formula I, and
   R², independently of one another, denotes a hydrogen radical or an alkyl group having 1 to 4 C atoms, a group —C(O)—R′ where R′=alkyl radical, a group —CH₂—O—R¹, an alkylaryl group, such as, for example, a benzyl group, or the group —C(O)NH—R¹,
   R³ is a linear, cyclic or branched or substituted, e.g. halogen-substituted, hydrocarbon radical having 1 to 50, preferably 9 to 45, preferably 13 to 37, C atoms,
   R7, independently of one another, may be R, R4 and/or a functionalized, organic, saturated or unsaturated radical substituted by hetero atoms and selected from the group consisting of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl or vinyl radicals. The various monomer units of the building blocks stated in the formulae (siloxane chains or polyoxyalkylene chain) may have a block composition among one another, with any number of blocks and any sequence, or may be subject to a random distribution. The indices used in the formulae are to be considered as statistical mean values.

In one embodiment of the invention the amount of the at least one surface-active additive according to the invention, % by weight based on the amount of binder is selected from the group of ranges consisting of 0.01 to 70% by weight, 0.01 to 50% by weight, 0.01 to 10% by weight, 0.05 to 5% by weight and 0.1% to 3% by weight, based on the amount of binder, are used in the production of the composite moulding.

The composite moulding is produced using preferably 99-0.1% by weight, in particular 99 to 1% by weight, of a cellulose-containing material, based on the total formulation.

Polyisocyanates, urea/formaldehyde, phenyl/formaldehyde and/or melamine/formaldehyde resins, alone or as mixtures with one another, can be used as binders. The proportion of binder in the composite moulding is 1 to 50% by weight, preferably 5 to 35% by weight and in particular less than 20% by weight, based on the total formulation of the composite moulding.

The composite mouldings according to the invention may contain further substances. In particular, the compositions according to the invention may contain further organic additives, surfactants and/or emulsifiers and/or solvents.

It may also be advantageous if the composition according to the invention contains a solvent, in particular an organic solvent, preferably a solvent which is not reactive towards isocyanates.

The invention furthermore relates to a process for the production of the composite mouldings by pressing glue-coated materials, in particular cellulose-containing materials. The process is distinguished in particular in that the pressing temperature during hot pressing is 0 to 400° C., preferably 100 to 300° C. and very particularly preferably 150 to 250° C.

In the process, advantageously the surface-active additive is introduced into the binder and the mixture is then applied by the customary methods familiar to the person skilled in the art, for example applied directly to the material or the engineering material.

The pressure reached during the pressing process is 0 to 100 bar, preferably 20-80 bar. The production of the composite mouldings is effected on continuous (roller pressing) as well as on batchwise (plate pressing) units.

The mouldings are used in the form of boards, blocks, strands and beams. These are used for the production of articles of all kinds, in particular for the production of pieces of furniture and furniture parts, and in house construction and interior finishing.

The invention furthermore relates to composite mouldings in the form of chip boards, OSB boards, fibre boards, plywood boards and/or cork boards, produced by one of said processes using the compositions according to the invention.

In one embodiment of the invention, addition of the surface-active substance to form the composite moulding results in a decrease in surface tension selected from the group consisting of at least 20%, at least 35% and at least 45%. The maximum decrease in surface tension may be between 50-100%.

In another embodiment of the invention, addition of the surface-active substance to form the composite moulding results in an increase in wetted area selected from the group consisting of at least 70%, at least 100% and at least 150%. The maximum increase in wetted area may be between 600-1000%.

In another embodiment of the invention, addition of the surface-active substance to form the composite moulding results in a decrease in swelling selected from the group consisting of at least 20%, at least 30% and at least 40%. The maximum decrease in swelling may be between 50-100%.

Further configurations of the invention are evident from the claims, the disclosure content of which is in its entirety part of this description.

The composite mouldings according to the invention, processes for the production thereof, binder compositions and the use thereof are described by way of example below, without it being intended to limit the invention to these exemplary embodiments.

Where ranges, general formulae or classes of compounds are stated below, these are intended to comprise not only the corresponding ranges or groups of compounds which are explicitly mentioned but also all partial ranges and partial groups of compounds which can be obtained by omitting individual values (ranges) or compounds.

The invention is further described by the following non-limiting examples which further illustrate the invention, and are not intended, nor should they be interpreted to, limit the scope of the invention.

### EXAMPLES

The structure of the compounds used in the use examples is shown in Table 1. The parameters mentioned in Table 1 relate to the abovementioned formula (I).

TABLE 1
Compositions of Examples 1 to 5, containing compounds
of the formula (I)

| | | | | | | R4* | | | | | |
|---|---|---|---|---|---|---|---|---|---|---|---|
| Ex. | Σa | Σb | Σc | Σd | R | x | y | R1 | R2 | R5 | R7 |
| 1 | 20 | 5 | 0 | 0 | CH₃ | 15 | 4 | CH₃ | CH₃ | CH₃ | — |
| 2 | 35 | 3 | 0 | 0 | CH₃ | 13 | — | — | 50% CH₃ | R4 | — |
| | | | | | | | | | 50% H | | |
| 3 | 30 | 2 | 0 | 1 | CH₃ | 15 | 8 | CH₃ | H | CH₃ | CH₃ |
| 4 | 40 | 3 | 1 | 0 | CH₃ | 15 | 8 | CH₃ | H | CH₃ | — |
| 5 | 0 | 1 | 0 | 0 | CH₃ | 10 | — | — | CH₃ | CH₃ | — |

*R4 = —CH₂—CH₂—CH₂—O—(CH₂—CH₂O—)ₓ—(CH₂—CH(R¹)O—)_{y}—R²

The additives can be used as pure substances but also as mixtures.

These additives are stirred directly into the binder and applied together with this to the shaped particles.

Classically, the composite base material, for example the cellulose-containing material, is initially introduced in fibre or particle form, mixed with the binder and then shaped in a metal press.

0.2% by weight of the surface-active substance was stirred into the corresponding binder and an amount of 40 μl was then applied to wood (spruce) and a metal plate. After 10 min, the spread of the drop was determined. In addition, the surface tension was measured with the aid of a Kruss tensiometer.

In order to investigate the swelling in thickness, compression mouldings having a diameter of 8.5 cm were produced from chips coated with the mixtures stated below. Thereafter, the compression mouldings were placed in water for 24 h and the thicknesses were determined before and after the storage in water.

In the case of the compressed mouldings of mixtures 1 to 4, 4% by weight of binder, based on the total formulation, were used; based on the proportion of binder, in each case 0.2% by weight of the surface-active additive is used. The glue mixture PMDI was prepared without addition of the additive.

4% by weight of pure PMDI were used as a binder in Comparative Example CM1, based on the total formulation, and a urethane-formaldehyde resin binder system—UF resin—was used in Comparative Example CM2. In the case of the UF resin, the proportion of binder was 10% by weight, based on the total formulation.

The results of the swelling in thickness are recorded in Table 2 in the form of percentage increases.

Examples according to the invention (mixtures 1-5):

Mixture 1 (PMDI): Bayer Desmodur® 1520 A20+0.2% by weight of Example 1
Mixture 2 (PMDI): Bayer Desmodur® 1520 A20+0.2% by weight of Example 2
Mixture 3 (PMDI): Bayer Desmodur® 1520 A20+0.2% by weight of Example 3
Mixture 4 (PMDI): Bayer Desmodur® 1520 A20+0.2% by weight of Example 4
Mixture 5 (UF): BASF Kaurit® Leim 350+0.2% by weight of Example 5
UF is a urethane-formaldehyde resin; amount of binder 10% by weight, based on the total formulation.
CM 1 PMDI without additive according to the invention, 4% by weight of binder
CM 2 UF resin without additive according to the invention, 10% by weight of binder
The percentage proportion of the additive is based on the proportion of binder.

TABLE 2
Wetting and swelling in thickness

| | | | Swelling in |
|---|---|---|---|
| | Surface | Wetted | thickness after |
| Glue mixture | tension | area | 24 h** |
| CM1 PMDI* | 45.0 mN/m | 286 mm² | 35% |
| Mixture 1 | 24.5 mN/m | 614 mm² | 27% |
| Mixture 2 | 22.1 mN/m | 774 mm² | 25% |
| Mixture 3 | 27.1 mN/m | 495 mm² | 24% |
| Mixture 4 | 26.3 mN/m | 531 mm² | 24% |
| CM2 UF resin* | 76 mN/m | 124 mm² | 43% |
| Mixture 5 | 23 mN/m | 248 mm² | 35% |

*Comparative experiment without addition of a surface-active substance
**Percentage increase, based on the linear dimension

Comparative Example CM1, pure PDMI without addition of the additive according to the invention, and Comparative Example CM2, the urethane-formaldehyde resin without further addition of an additive, show comparatively low values for the wetted area, while the examples according to the invention of mixtures 1 to 5 show substantially increased wetted areas and also have substantially reduced surface tensions.

Surprisingly, the wetted area increases at least by substantially more than 50% on addition of only 0.2% by weight of the additive according to the invention (based on the amount of binder), by 115% in the case of mixture 1, by 171% in the case of mixture 2, by 73% in the case of mixture 3, by 186% in the case of mixture 4 and by 100% in the case of mixture 5, relative to the UF resin.

Also remarkable is that the swelling in thickness after storage in water is substantially reduced if an additive according to the invention is added to the binder.

The comparative experiments relating to the use without surface-active substance also demonstrate that, for achieving the same properties of the composite moulding, at least 15% by weight, preferably 25% by weight, of binder can be saved, which leads to a cost benefit.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. Composite moulding produced using a composition containing at least one binder and at least one surface-active additive.

2. Composite moulding according to claim 1, characterized in that the surface-active additive is an organic, preferably an organometallic and/or an organosilicon compound.

3. Composite moulding according to claim 2, characterized in that it consists of cellulose-, glass-, mineral-, polymer- and/or metal-containing materials.

4. Composite moulding according to claim 2, characterized in that the surface-active additive is a compound of the general formula (I) 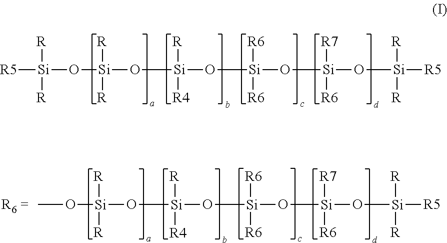
in which
a, independently of one another, is 0 to 500,
b, independently of one another, is 0 to 60,
c, independently of one another, is 0 to 10,
d, independently of one another, is 0 to 10,
with the proviso that, per molecule of the formula (I), the average number Σd of the T units and the average number Σc of the Q units per molecule are in each case not more than 50, the average number Σa of the D units per molecule is not more than 2000 and the average number Σb of the silyloxy units carrying R4 per molecule is not more than 100,
R, independently of one another, is at least one radical from the group consisting of linear, cyclic or branched, aliphatic or aromatic, saturated or unsaturated hydrocarbon radicals having 1 to 20 C atoms,
R5, independently of one another, is R4 or R,
R4, independently of one another, is an organic radical which is not R, or a fragment selected from the group consisting of
—CH₂—CH₂—CH₂—O—(CH₂—CH₂O—)ₓ—(CH₂—CH(R¹)O—)_{y}—R²
—CH₂—CH₂—O—(CH₂—CH₂O—)ₓ—(CH₂—CH(R¹)O—)_{y}—R²
—CH₂—R³
—CH₂—CH₂—(O)_{x′}—R³
—CH₂—CH₂—CH₂—O—CH₂—CH(OH)—CH₂OH 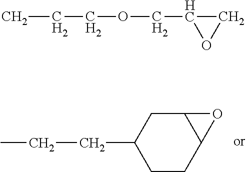
—CH₂—CH₂—CH₂—O—CH₂—C(CH₂OH)₂—CH₂—CH₃, in which
x is 0 to 100,
x′ is 0 or 1,
y is 0 to 100,
R¹, independently of one another, is a substituted or unsubstituted alkyl or aryl group having 1 to 12 C atoms, it being possible for substituents R¹ differing from one another to be present within a radical R4 and/or a molecule of the formula I, and
R², independently of one another, denotes a hydrogen radical or an alkyl group having 1 to 4 C atoms, a group —C(O)—R′ where R′=alkyl radical, a group —CH₂—O—R¹, an alkylaryl group or the group —C(O)NH—R¹,
R³ is a linear, cyclic or branched or substituted hydrocarbon radical having 1 to 50 C atoms,
R7, independently of one another, may be R, R4 and/or a functionalized, organic, saturated or unsaturated radical substituted by hetero atoms and selected from the group consisting of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl or vinyl radicals.

5. Composite moulding according to claim 1, produced using 99 to 0.1% by weight of at least one cellulose-containing material.

6. Composite moulding according to claim 1, produced using 1 to 50% by weight of at least one binder.

7. Composite moulding according to claim 1, produced using 70 to 0.01% by weight of at least one surface-active additive, based on the amount of binder.

8. Composite moulding according to claim 1, produced using further additives, surfactants, solvents and/or emulsifiers.

9. Process for the production of a composite moulding according to claim 1 by continuous or batchwise pressing of binder-coated materials.

10. Process according to claim 9, characterized in that the pressing temperature is 0-400° C. at a pressure of 0 to 100 bar.

11. Process according to claim 9, characterized in that polyisocyanates, urea/formaldehyde, phenol/formaldehyde and/or melamine/formaldehyde resins, alone or as mixtures with one another, are used as binders.

12. Process according to claim 9, characterized in that the surface-active additive is introduced into the binder and the mixture is then applied to the material.

13. Method for the production of articles of all kinds, in particular boards, blocks, beams or strands using the composite moulding according to claim 1.

14. Method for the production of pieces of furniture and furniture parts, of packaging materials, in house construction and interior finishing using the articles according to claim 13.

15. Composition containing an organic binder and at least one surface-active substance for use in one of the processes according to claim 9.

16. Composition according to claim 15, characterized in that the surface-active substance is a siloxane of the formula (I).

17. Composite moulding in the form of a chip board, OSB board, fibre board, plywood board and/or cork board, produced by a process according to claim 9.

18. Composite moulding according to claim 5, produced using 1 to 50% by weight of at least one binder.

19. Composite moulding according to claim 18, produced using 70 to 0.01% by weight of at least one surface-active additive, based on the amount of binder.
